(19) United States
(12) Patent Application Publication
(10) Pub. No.: US 2025/0349223 A1
(43) Pub. Date: Nov. 13, 2025

(54) SIMULATION SYSTEM AND METHOD FOR TRAINING IN ELECTRONIC COUNTER MEASURES

(71) Applicant: ARGON ELECTRONICS (UK) LIMITED, Luton (GB)

(72) Inventor: Steven PIKE, Luton (GB)

(21) Appl. No.: 18/867,562

(22) PCT Filed: May 24, 2023
(86) PCT No.: PCT/GB2023/051363

§ 371 Date: Nov. 20, 2024

(30) Foreign Application Priority Data
May 31, 2022 (GB) 2208025.3

(51) Int. Cl. G09B 9/00; G08B 21/02; H04W 4/02; H04W 4/029

(52) U.S. Cl. CPC G09B 9/003; G08B 21/02; H04W 4/026; H04W 4/029

(57) ABSTRACT

An electronic counter measures simulation system, method and associated devices. The system is implemented by use of a portable simulation device, configured with a simulated mission profile determined according to a simulation exercise, and portable tracking devices carried by each member of a patrol unit. The system monitors whether a member of the patrol unit strays outside a protective umbrella simulated by the device. During preparation for the exercise the device is provided with a set of antennas, at least one of which should be selected according to the simulated mission profile. The “type” of antenna is identified by the simulation device so it can be determined whether the correct selection has been made.

### TECHNICAL FIELD

The present invention relates to a simulation system, device and associated method for training individuals in the correct use and protocols of electronic counter measures associated with avoiding and mitigating threats associated with Explosive Devices, including improvised explosive devices (IEDs) and, in particular, IEDs which may be remotely detonated by means of wireless activation.

### BACKGROUND TO THE INVENTION

Personnel responsible for ensuring the security of an environment will need to patrol the area of concern to verify that no threat exists. One such threat is an IED that might be triggered wirelessly by an adversary once the patrol is seen to be within the “kill range” of the IED. Typically, a receiver mechanism would be wired to the IED detonator, and an associated transmitter/transceiver would be used to send a detonation command from a safe distance when the target (e.g. a patrol) comes within the IED blast range. Alternatively, the wireless command might be used to “arm” the IED which will subsequently detonate by independent means such as a pressure switch.

The transmitter/receiver combination can comprise a variety of different technologies ranging from an adapted toy model controller or garage door opener to sophisticated frequency hopping radio link or even a cellular radio configured such that the called device detonates the IED upon receipt of a call or text message.

In order to avoid a close proximity IED blast detonated wirelessly, safety measures are available. For example, a patrol may carry an electronic counter measure (ECM) system comprised of a backpack-worn radio transmitter or, in more sophisticated systems, radio transceiver. An ECM may also be deployed as a fixed, vehicle or shipboard mounted asset.

An ECM system is essentially a high power very wideband transmitter that creates an interfering signal that is intended to “jam” or disrupt the ability of the IED receiver to receive the signal broadcast from the transmitter to represent a detonation command signal to the IED. However, because the team using the ECM will also have its own operational radio communications equipment, the ECM is preferably programmed not to jam specific frequencies to ensure an operational communications means is maintained.

The ECM in effect creates an electromagnetic “protective umbrella” around itself such that, provided the members of the patrol ensure they remain within the confines of this protective umbrella, they should remain safe from harm. This is because, in the event the patrol manoeuvres within an area where a hidden IED may be located, its detonation by means of remote radio control is inhibited. In most practical ground implementations, protocol would require that members of the patrol need to ensure they remain for example, within a 25 to 100 metre radius of the ECM, however, the 100 metre radius may only be appropriate in a totally open area, that is to say “line of sight” of the ECM with no form of electromagnetic shielding between the patrol member and the ECM.

Where the nature of the threat is such that a single ECM unit is unable to provide effective electromagnetic protection, multiple ECM units will be deployed, each configured to jam different bands of frequency, and all being synchronised to ensure effectiveness of protection across the entire band of frequencies of concern.

In the event that any obstruction, such as a building or wall, should come between the ECM and the patrol member then this obstruction will cause electromagnetic shielding and potentially compromise the effectiveness of the protective umbrella for that individual or portion of the patrol. Furthermore, certain operational situations may require that the ECM is placed at ground level (either vertically or laid flat on the ground), which will reduce the diameter of any protective umbrella, something that all parties dependent upon its protection should be conscious of.

Failure to consider the effect of any reduction in protection may result in detonation of the IED and consequential injury or loss of life. Known as “situational awareness”, the need to ensure ECM operatives and the associated patrol members understand the importance of maintaining the integrity of the protective shield is a critical element of training in the correct use of the application of ECM. However, the nature and variety of radio communications technology available to an adversary for implementing remote detonation is extremely diverse, and technical limitations or compromises mean that any ECM must be carefully configured to protect against the perceived electromagnetic threat that may be present in the operational location at that specific time. Therefore, it is important that technical knowledge relating to the potential threat is acquired and this knowledge used to configure the ECM to ensure effective protection. For example, due to the very wide bandwidth over which the ECM operates, a variety of antennas are required to ensure optimal radio operation throughout the selected radio frequency bands for which protection is required.

This threat collection and evaluation is usually carried out independently to create what is known as a “mission profile” which needs to be transferred to the ECM either by temporary connection or by means of a “configuration key” programmed with the mission profile for issue to the ECM operator who then has to ensure the configuration is correctly set, the correct mission profile is selected and the appropriate antenna systems utilised for each specific mission. When a patrol is being planned, any threat assessment would be considered, and the proposed patrol route optimised to mitigate risk. The patrol leader is then tasked to ensure the planned patrol route is adhered to.

Threat analysis and subsequent ECM configuration and mission profile selection are critical otherwise the electromagnetic protective umbrella will be ineffective. For example, the configuration setting and mission profile programmes the ECM to generate a specific electromagnetic signal but, for effective operation, the correct antennas must also be installed. Any pre-planned patrol route should also be carefully followed.

The ability to use real-world ECM equipment for training is extremely limited due to the broad band electromagnetic emission of these systems which, when used, disrupt all non-military communications within typically a 1-2 Km radius, an effect which is unacceptable in a modern world that so dependent upon radio communications (e.g. cellular radio, Wi-Fi®, Blue Tooth®). Additionally, the only means by which the individual patrol members can be monitored for correct situational awareness and protective procedure is by visual observation; an approach which is subjective and limits the effectiveness of objective performance evaluation and learning enhancement.

### SUMMARY OF THE INVENTION

The present invention seeks to implement a training simulation system solution for users of electronic counter measures equipment that at least provides an alternative to practising with the real thing.

The invention is embodied by a system according to claim 1, e.g. a means to simulate either a generic representation of, or specific electronic counter measure (ECM) equipment that would be used to mitigate real world explosive threats. The invention may further provide a means to train and evaluate an ECM operator and the associated patrol team such ECM equipment should protect. A further embodiment may comprise an appendage training device which, when combined with an operational ECM, results in the provision of a training capability.

The system may comprise as a whole or be divided into several components, namely:
a) A simulation electronic counter measure (ECM) device which may incorporate a processor, human interface controls and display, configuration for two way radio communications (e.g. to enable communication between associated portable tracking devices and instructor exercise control console), a positioning/location determining capability (e.g. GPS), a selection of antennas with a means of antenna identification, a means to determine its physical orientation, a means to accept/receive data relating to a simulated mission profile and a power supply (e.g. battery).
b) A portable tracking device which may incorporate a processor, human interface controls and display, configuration for two-way radio communications (e.g. to communicate with associated ECM simulator and instructor exercise control console), a positioning/location determining capability (e.g. GPS), an antenna, a means to determine its physical orientation and a power supply (e.g. battery). A tracking device (or other part of the system) may include provision to alert the “status” of a participant, i.e. where a participant is rendered in danger or dead within the simulation exercise. Provision for status could be by means of an audible/visual/tactile alarm.
c) An exercise control console which may incorporate a processor, human interface controls and display, configuration for two-way radio communications (e.g. to communicate with an associated ECM simulator and portable tracking devices as above), a positioning/location determining capability (e.g. GPS), an antenna, and a power supply (e.g. battery).
d) An IED trigger simulation device (e.g. separate or incorporated with exercise control console), as a means to simulate a detonation command to an explosive device, e.g. for the purpose of detonating a training pyrotechnic/explosion in the event the ECM procedure was not carried out correctly.
e) A means to simulate the detection of a simulated IED trigger where the actual ECM incorporated such a detection capability for the purpose of warning the patrol of a live threat.

It is noteworthy that the simulation trigger will be a known frequency for training purposes and may share the same frequency as the ECM simulator. The ECM simulator of the invention is not configured to actively “jam” any signal (since it is the fact that the real equipment jams that makes training problematic). As mentioned, one means to simulate the IED trigger could be from the control console, e.g. by manual activation by instructor, but it could also be arranged to be automatic based upon patrol member location and if that patrol member does not maintain the protection of the ECM.

It is further noteworthy that the simplest form of real world ECM equipment simply jams enemy radio/activation signals and it may never be known if a threat has been neutralised. More advanced ECM equipment also has a receive mode and can “listen out” for a potential IED trigger signal and, upon recognizing this, initiate a jam. Yet more advanced technology may be configured to capture a trigger signal and permit its use for future protection by itself and other equipment—i.e. a form of self-learning.

A means to simulate detection of an IED trigger may be a feature of the invention, in line with real word capabilities. This is useful because a) certain real equipment may have a means to indicate this occurrence and b) a training scenario could be based upon having a few training IEDs deployed and, through after action review, see how close or otherwise the team came to being harmed by an IED.

An alternative expression of the invention includes: a simulation device for an electronic counter measures training system, comprising: a processor configured for receiving a predetermined simulation mission profile; a transceiver, controlled by the processor; and at least one connector in communication with the transceiver, in combination with at least one antenna connectable with the at least one connector; wherein the at least one antenna is selectable from a set of antennas.

A further aspect relevant to the invention involves a means by which operational (i.e. “real-world”) ECM equipment can be configured for training use. In such a form, the ECM equipment may be configured as a transceiver to communicate with a chosen radio channel and said communication employs a suitable format such that it can be detected and analysed by a patrol member portable tracking device for the purpose of determining the quality and integrity of the simulated protection umbrella, the portable tracking device location and resulting analysis of the protective umbrella signal being returned to the exercise control console. Indeed, the member's distance from the ECM may be determined and suitable measures (e.g. warning/alert) taken if a member strays from the protective umbrella.

In the event the operational ECM does not incorporate a means of determining its location and a means when in training mode to communicate that location information to a training exercise control processor, a specific tracking and communications module may be provided to accompany the operational ECM unit to facilitate training exercise control processor monitoring of the operational ECM unit's location and orientation.

### BRIEF DESCRIPTION OF THE DRAWINGS

FIG. 1 illustrates a representative view of a simulation device according to one aspect of the invention;

FIG. 2 illustrates a representative view of a tracking device according to an aspect of the invention;

FIG. 3 illustrates a representative view of a control device according to an aspect of the invention;

FIG. 4 illustrates a schematic view of a simulation device according to one aspect of the invention;

FIG. 5 illustrates a schematic view of a tracking device according to one aspect of the invention;

FIG. 6 illustrates a schematic view of a control device according to one aspect of the invention; and

FIG. 7 illustrates a schematic view of an ECM simulation system according to the invention.

### DETAILED DESCRIPTION OF THE INVENTION

The following description presents exemplary embodiments and, together with the drawings, serves to explain principles of the invention. However, the scope of the invention is not intended to be limited to the precise details of the embodiments or exact adherence with all features, since variations will be apparent to a skilled person and are deemed also to be covered by the description. Indeed, the present disclosure may separately define a number of discrete inventions. Terms for components used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation, e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” are used for convenience of explanation usually with reference to the illustrations and are not intended to be ultimately limiting if an equivalent function can be achieved with an alternative dimension and/or direction.

The description herein refers to embodiments with particular combinations of steps or features, however, it is envisaged that further combinations and cross-combinations of compatible steps or features between embodiments will be possible. Indeed, isolated features may function independently as an invention from other features and not necessarily require implementation as a complete combination.

In terms of preparation for use of ECM in the real world, an assessment of an IED threat and the potential technology that might be used to wirelessly initiate the IED will have been carried out and an electromagnetic “threat profile” (generally referred to as a “mission profile”) created. This mission profile will be installed into the ECM equipment which may store a number of such mission profiles from which one or more will be selected to configure the specific nature of the ECM emission that will form the protective umbrella. An assessment of the area to be patrolled will also be carried out and a plan created that represents the most efficient, thorough, and safest route for the patrol to take. This threat assessment can optionally include a software modelled profile of the patrol area.

In the context of the invention, an analogous simulated mission profile will be installed into the ECM simulator by or for the operator who will also be advised which antennas are required to ensure correct operation and effective protection.

An example of ECM simulator is illustrated by FIG. 1. Specifically, the ECM-SIM unit 11 comprises a plurality of antenna connections 12 to which an appropriate antenna 13 must be connected. The antenna 13 is selected from a set of antennas (e.g. that look different or at least have identifiable indicia, unique connectors or characteristics) based on the specific threat profile selected for the training exercise.

The mission profile is transferred by wire, wireless or stored in a suitable transfer device, e.g. a memory stick 15 or flash card, which is inserted into a receiving communication port 14. A positioning capability sensor 16, such as the global positioning system (GPS), provides the unit operator with location information. A means of determining orientation (e.g. gyroscope 17) of the unit 11 is also provided. A power pack, for example battery 18 provides power for the equipment.

A functional diagram of the components from unit 11 is shown in FIG. 4.

As mentioned, to replicate the situation whereby an ECM operator must ensure the most appropriate antenna is installed for the specific threat identified, a variety of antennas will be provided with the simulator unit 11, e.g. having different physical appearance as with real ECM antennas and each having a unique means of technical identification discernible by the unit. However, in a preferred form, each antenna of the set of antennas for the simulation unit should have, in fact, the same technical characteristics due to the ECM-SIM always using the same radiocommunications technology, regardless of the type of antenna being simulated. In this way the training system is capable of use without interfering with general public of commercial communications.

The invention is embodied by a device with a selection of different antennas (chosen according to the mission profile) but which are, in fact, operationally the same. However, it is notable that the real systems use extremely wide bandwidth transmitters (e.g. 30 MHz to 4 GHz) but, rather than jam that entire band, rely upon intelligence (i.e. the mission profile) to select which specific sections within that band to jam. The problem for real world systems is that no one antenna is capable of operating with optimal efficiency throughout the entire band. The user therefore has to select the appropriate antenna(s) for a specific mission. The present invention seeks to simulate this requirement. Furthermore, due to the antenna frequency response characteristics the correct antenna will not provide a consistently sized protective umbrella across the frequency band concerned, the appreciation of which in an important aspect of training.

Use of the wrong antenna in the real world would result in the jam signal being compromised. The training system will only need to use one frequency because in essence it is simply a tracking system. In order to replicate the need to fit the appropriate antenna (corresponding to real world options) the system will have a variety of simulated “look alike” antennas (each appears physically different) but technically they will all be the same. It is also preferable to incorporate a means by which each simulated antenna can be uniquely identified by the training ECM so it can be determined if the user has selected the correct antenna for the mission. This may be possible by simple electronic tagging (e.g. radio frequency identification device, “RFID”) between the antenna 13 (e.g. incorporating passive RFID) and unit 11 (e.g. having an RFID reader at the connector 12).

When the ECM simulator has a means to determine that the correct simulation physical antenna in relation to a specific threat profile has been installed, this information can be transferred to the central exercise controller for recording and reporting.

According to the system, each of the patrol members may be issued with a tracking device which is wirelessly linked to the ECM simulator and central exercise controller. The tracking device can determine the position of the patrol member and therefore the distance between the patrol member and the ECM simulator can be calculated for the purpose of determining if the patrol member remained within the protective umbrella and the agreed patrol route was followed. Technically determining the orientation of the tracking device and therefore the patrol member is useful for the purpose of assessing the degree of potential injury or death in the event of IED detonation based upon the physical orientation of the patrol member.

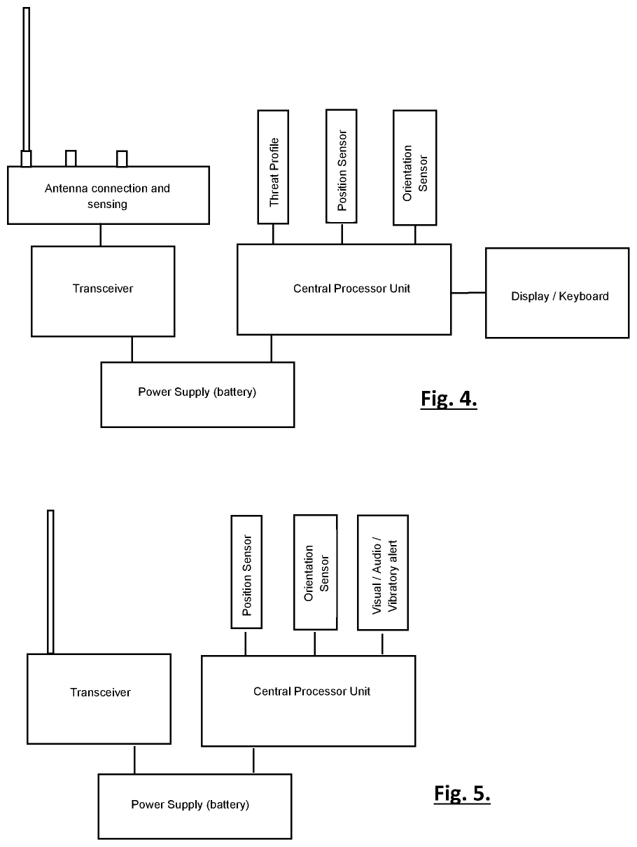

A tracking device 19 is shown by FIG. 2, e.g. comprised of an antenna 20, a means of position determination (e.g. GPS module 21), a means of determining of orientation (e.g. gyroscope 22) and a means of supplying power, such as battery 23. A functional diagram of the components from unit 19 is shown in FIG. 5.

Implementation of a tracking device is believed to be unique to a simulation situation, i.e. no tracking or warning is available on real equipment. A degree of injury or death can be determined by having a means to monitor within the control system when specifying nature of weapon and blast radius. However, in a related aspect of the invention, it is useful for a real world system to also use a tracker/tag capable of analysing the integrity of the protection provided by the ECM emission to warn a member if they are straying from the protective umbrella.

The ECM simulation system may analyse the quality of the communication between itself and each of the tracking devices and, using this signal quality analysis in conjunction with positional information, assess the degree of physical shielding that exists between the ECM simulator and patrol member and, therefore, the ability of the patrol member to maintain situational awareness and ensure effective personal ECM protection. An alternative means to determine the presence of and therefore protection provided by physical shielding would be by use of a digital representation of the training area with all physical structures and their expected attenuation of any signal suitably modelled and incorporated within the exercise control system or ECM simulator as appropriate.

An independent simulated IED trigger (not illustrated as separate component) will permit a training instructor to activate a simulated threat. In one form this may trigger a pyrotechnic training explosion to further emphasize consequences of failing to follow correct ECM process. In other forms or in addition, the simulator unit (device) may display an explosion alert and/or sound/vibration. The tracking device held by a participant in the simulation may also react to a detonation such as by vibration.

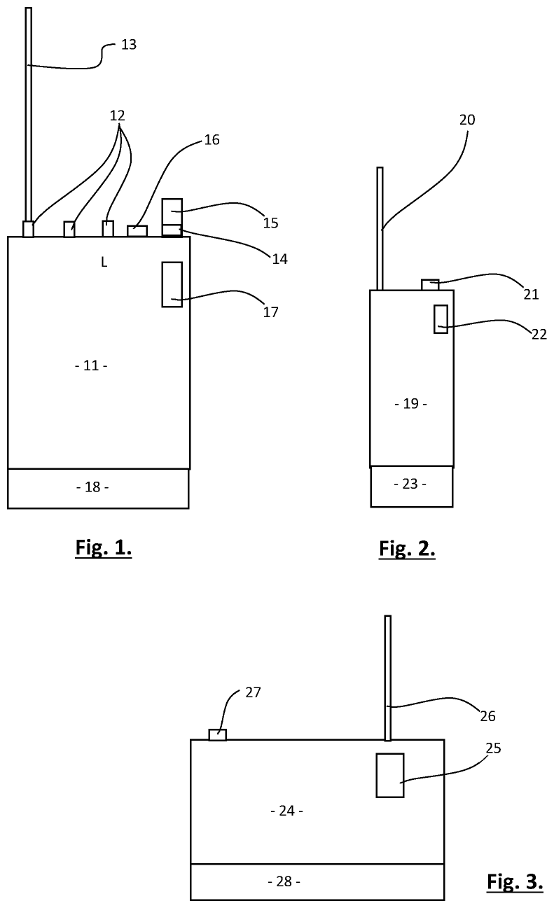

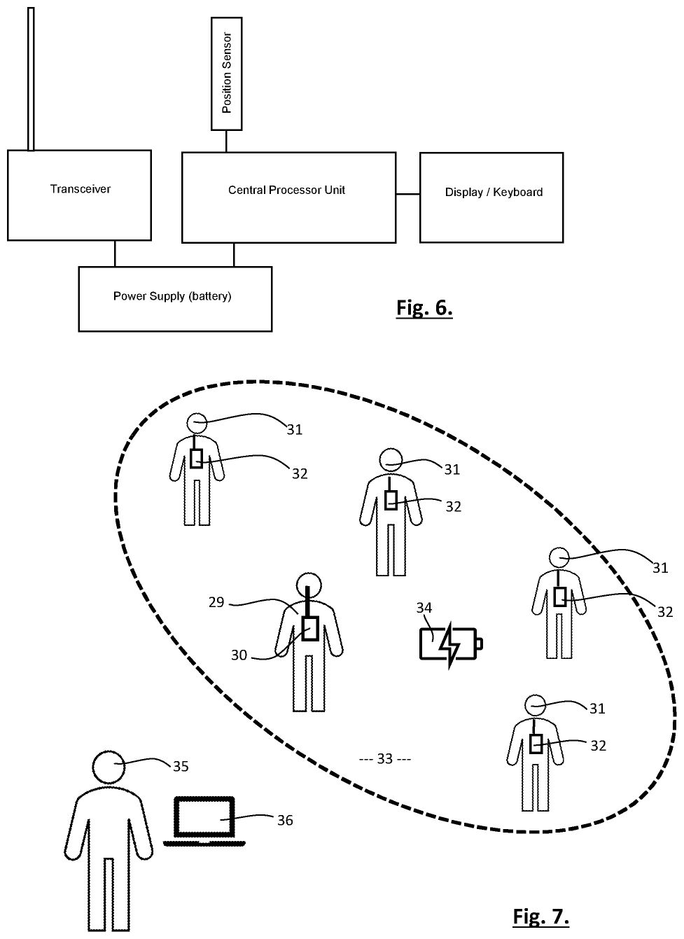

FIG. 3 illustrates an instructor/exercise control console 24, e.g. incorporating a transceiver 25 to facilitate communications between the simulation unit 11 carried by a patrol ECM operator and tracking device 19 carried by patrol members to be protected by one or more ECM units, via an antenna 26. There may be a means to determine position (e.g. GPS module 27) and a means of power, e.g. battery 28. The instructor control console 24 will incorporate software to control, monitor and analyse functions and activity related to the simulation exercise in operation. A functional diagram of the components from unit 24 is shown in FIG. 6.

In one form, controller 24 is a central exercise control computer wirelessly linked to the one or a plurality of simulator equipment 11 and one or a plurality of tracking devices 19 to enable an instructor to monitor and record the patrols route and activities in real time. The central exercise controller 24 will also enable the actual route taken to be compared with the pre-planned safe patrol route and highlight any discrepancy. This route comparison can also incorporate any software-based modelling of the patrol route that may have taken place to determine compliance to any recommended patrol route.

The exercise control unit 24 may be optional to the system as a whole. For example, in one form of the invention, the portable simulation unit 11 may be incorporated with a means to report if a person/tracking device strayed outside of the protective umbrella and monitor same. The capability to include a simulated IED and simulated trigger is optional.

By way of summary, FIG. 7 illustrates the simulation system of the invention in overview. For example, an ECM student operative 29 carries a simulation device 30 (as shown in FIG. 1) to protect student patrol members 31, each of whom are carrying a tracking device 32 (as shown in FIG. 2). Device 30 simulates a protective electromagnetic umbrella 33, relative to an improvised explosive device 34.

An exercise instructor/observer 35 may consult an exercise control device 36 (as shown in FIG. 3) to monitor the ECM exercise in real time. All events, including movement of patrol students 31 can be monitored in real time and recorded for subsequent review. The exercise observer 34 may also use exercise control device 36 to remotely detonate simulated IED 34 as required during the exercise.

Any deviation from correct equipment use or ECM patrol procedure can be reported on the exercise control unit in real time while also being recorded enabling the simulation to be analysed after an exercise (i.e. not necessarily in real time) to assess performance, debrief the students and review learning outcomes. The ECM simulator and central control computer may also be integrated with “combined arms training systems” where ECM and IED mitigation forms an element of a larger scale battlefield training scheme. In any event, all training activity is preferably recorded to facilitate after action review (AAR) once the training exercise is completed.

Further optional features of note for further explanation related to the invention include:
1. A simulated IED device can be provided for use with the system. This may incorporate a means to determine its location, e.g. so that the participants should ensure a safe distance exists between the ECM equipment and the IED to avoid the risk of induced detonation (an effect caused due to the electromagnetic field created by the ECM equipment inducing sufficient energy into the IED waiting to cause detonation. In this case, the instructor control unit 24 may therefore incorporate a means to inform if proximity to the simulated IED is less than a predetermined threshold, and also either permit the instructor to initiate the simulated IED or arrange for automatic activation of the simulated IED.
2. Due to the active bandwidth limitations of an ECM (while they are wide bandwidth, generally only a portion is used for any one profile to avoid there being too much time taken for the energy sweep, such that a frequency of concern is not fully jammed and a trigger signal may “sneak in the gap”) a patrol may employ more than one ECM, each having a different “threat (or mission) profile” incorporated. Particularly:
   a. A sim unit 11 preferably supports a number (typically four) mission/threat profiles, the user having to select the appropriate threat profile;
   b. A patrol may carry more than one sim unit 11, such that the combined effect of each protective umbrella provides an overall protective umbrella;
   c. When ECM is used in this manner, each ECM synchronizes with each other for maximum effectiveness. This can be simulated within the system parameters;
   d. In the event use is as described in c. above, GPS may be used to provide synchronisation and, therefore, if GPS is lost an alarm sounds on the ECM. It is desirable to simulate a “lost GPS alarm” within the system;
3. In respect of the antennas used, the unit 11 should be capable of simulating a voltage standing wave ratio (VSWR) alarm to simulate a failure of the installed antenna. The initiation of this simulated alarm can be by means of instructor controller.

In various broad aspects, the invention recognises:
1. A device to simulate the physical appearance and operation of real world ECM equipment, such that the appearance and operation may be generic or represent a specific operational ECM in use. The simulation device will incorporate a transceiver with the ability to communicate with (optionally) a central control computer and independent tracking units carried by each of the associated patrol members. The simulation device will also have a means to determine its own location. Preferably the device operates for communication in a relatively narrow frequency range, at least compared to the wide band jamming capabilities of a real world ECM.
2. A device configured to communicate with tracking units (and optionally a control computer) that can be temporarily physically appended to retrofit a real world ECM such that, when combined, the ECM can be used in a simulation exercise.
3. The simulation device may have the following additional capabilities/configuration alone or in combination:
   a. determining orientation, e.g. a gyroscope, tilt sensor;
   b. port to load a simulated “mission profile” that represents the way a specific model of real world ECM should be configured, based upon intelligence received in respect of the radio system that might be used to trigger an IED;
   c. connection(s) for a variety of simulated antenna, preferably with a further means by which different simulated antenna can be uniquely identified to confirm that the correct antenna has been installed, e.g. for a specific mission profile;
   d. determining the quality and integrity of communication between the patrol member tracking device and the ECM-SIM for the purpose of evaluating the quality and integrity of ECM simulated protection provide by the protective umbrella.
4. A tracking device, as a separate component, interoperable with the simulation device and/or the exercise control processor. The tracking device may be worn by each patrol member, having the ability to communicate with the simulation device such that the quality of the signal and the distance between the tracking device and the simulation device can be determined. Orientation of the tracking device may be monitored by suitable means.
5. The tracking device and/or simulation device may be configured for alerting (audio, visual, vibratory) if a patrol member's safety has been compromised.
6. A central exercise control processor, as a separate component interoperable with the simulation device or integrated therewith. Exercise control operations may be linked wirelessly to the simulation device such that the location and path through which it and the associated patrol member tracking devices can be monitored, and the associated signal quality related to shielding and protection can be assessed in real time and recorded for later performance analysis.
7. The simulation system/method, central control processor and/or simulation device may have the following capabilities/configurability:
   a. Determination of position and route taken by the simulation device;
   b. Determination of position and route taken by an associated patrol member via a tracking device;
   c. Determination, recordal and reporting of the quality of a communication link between the simulation device and an associated tracking device;
   d. Determination and recordal of the distance between each tracking device and the simulation device and/or the distance between each tracking device at any time throughout the exercise;
   e. Monitoring and recordal of the duration of a patrol;
   f. Comparison of the actual patrol route carried out with the pre-planned patrol route to evaluate compliance;
   g. Determination and recordal of the orientation of the simulation device;
   h. Recordal and reporting of the orientation of the patrol member tracking device;
   i. Monitoring and recordal of the correct use of the ECM;
   j. A means whereby a simulated IED is triggered in the event a patrol member fails to ensure effective protective umbrella cover. Such feedback enhances the understanding of importance of following correct process;
   k. A means whereby a simulated IED is triggered in the event an ECM is placed too close to the simulated IED thereby simulating detonation of n IED by means of induced signal.
   l. Reporting of any deviation of correct use of the equipment;
   m. Reporting of any failure to follow correct operational procedure;
   n. Determination/assessment of the overall performance of the ECM operator and the individual patrol members in real time, recorded and made available for subsequent after-action review and learning enhancement;
   o. A means to be integrated with “combined arms training systems” where ECM and IED mitigation forms an element or a larger scale battlefield training scheme.

It is believed that there is no means for a real world system to determine if a patrol member is within the protective umbrella and, in any event, even turning on real world systems for training is problematic (due to potential unintended communications interference). Accordingly, any presently known equipment that were to incorporate a training mode would be limited in function to just being able to practice pressing the various buttons and menu features without any operational response. This has limited training value.

It is noteworthy that the tracking device aspect of the invention extends, in particular the capability to communicate with an ECM patrol operator unit to determine if within a protective umbrella and alert a user (command and/or individual) if not, to real world equipment. In other words, an enhanced real world operational ECM system where members of a patrol receive active feedback, via a tracking device or other means to determine their location and the integrity of the ECM protective umbrella, as to their individual safety relative to a protective umbrella during a patrol.

In this aspect, an invention may be defined as a tracking device configured for use with an operational ECM system or device, comprising: an identification element; and an alert means for notifying a wearer of its status relative to a protective umbrella as determined by the operational ECM system or device.

The present invention envisages and encompasses reprogramming a real world ECM unit for training purposes, in line with the inventive concepts identified, e.g. interaction with tracking devices and recognising whether a correct antenna type has been selected. For the avoidance of doubt, an operational ECM could be temporarily reconfigured as a training ECM (since it is a processor with a software defined radio) in accordance with the invention.

It is also feasible to perform the method/implement the system of the invention in a virtual space, i.e. a simulation capability in a virtual sense. In such a scenario a virtual ECM training system features a virtual operator and patrol all being tracked. The other general features (save for GPS) described herein for a physical embodiment may function as a virtual equivalent.

In summary, the present disclosure relates to an electronic counter measures simulation system, method and associated devices. The system is implemented by use of a portable simulation device, configured with a simulation mission profile determined according to an intended simulation exercise, and portable tracking devices carried by each member of a patrol unit. The system monitors whether a member of the patrol unit stays within a protective umbrella simulated by the device. Members can be informed whether correct protocols have been followed either in real time or during analysis after the exercise is complete. During preparation for the exercise the device is provided with a set of antennas, at least one of which should be selected according to the mission profile. The “type” of antenna is identified by the simulation device so it can be determined whether the correct selection has been made.

1. A training simulation device for an electronic counter measures training system, ECM, comprising:
a processor configured for receiving a predetermined simulation exercise mission profile; and
a transceiver, controlled by the processor, configured for communicating with a tracking unit.

2. The training simulation device according to claim 1, further comprising at least one connector in communication with the transceiver, in combination with at least one antenna connectable with the at least one connector; wherein the at least one antenna is selectable from a set of antennas.

3. The training simulation device according to claim 2, wherein each antenna of the set of antennas includes, alone or in combination, either of:
an identification element;
a common frequency response configuration.

4. The training simulation device according to claim 3, wherein the identification element is readable by the processor and/or corresponds to specific physical features of each antenna.

5. The training simulation device according to claim 1, further comprising a location and/or orientation determining element.

6. (canceled)

7. The training simulation device according to claim 1, wherein the processor is further configured for:
determining the quality, distance and/or integrity of communication of a tracking unit; and/or
simulating detection of an improvised explosive device, IED, trigger.

8. A tracking device configured for use with an electronic counter measure, ECM, and/or training simulation device according to claim 1, comprising: an identification element and an alert means for notifying a wearer of its status as determined by the training simulation device.

9. (canceled)

10. An exercise control device configured for use in an electronic counter measures training system with a training simulation device according to claim 1, comprising:
a processor;
interface controls and display; and
a transceiver for communication with the simulation device and one or a plurality of tracking devices associated with the simulation device.

11. (canceled)

12. The exercise control device of claim 10, further comprising a training simulation improvised explosive device, IED, trigger element.

13. An electronic counter measures, ECM, training simulation system, comprising:
at least one portable training simulation device having: a processor, configured for receiving a predetermined training exercise mission profile; a transceiver; a set of antennas, wherein at least one antenna of the set of antennas can be selected according to the predetermined training exercise mission profile and coupled to the transceiver;
at least one portable tracking device, configured for communication with the at least one training device, for determining a distance of the at least one portable tracking device from the portable training simulation device.

14. The system of claim 13, wherein the portable training simulation device and/or the at least one portable tracking device comprises an orientation determining element.

15. The system of claim 13, further comprising an exercise control device having a processor; interface controls and display; a transceiver for communication with the training simulation device and the at least one tracking devices.

16. The system of claim 13, further comprising a training simulation improvised explosive device, IED, trigger element.

17. An electronic counter measures, ECM, training simulation method, comprising:
determining a training exercise mission profile based upon operational characteristics to be simulated;
providing at least one ECM training simulation device for carrying by a patrol unit in a training exercise;
providing a portable tracking device to a plurality of members of the patrol unit;
wherein the location of each portable tracking device is monitored relative to the at least one electronic counter measure, ECM, training simulation device.

18. The method of claim 17, wherein the at least one electronic counter measure, ECM, simulation device is further provided with a set of antennas, at least one antenna being selectable to be connected to the ECM training simulation device.

19. The method of claim 18, comprising monitoring whether the at least one antenna selected for connection to an electronic counter measure, ECM, training simulation device is correct, according to the training exercise mission profile.

20. The method of claim 17, wherein the location of each portable tracking device is monitored for whether it strays outside a simulated protective umbrella of electronic counter measures, ECMs, provided by the at least one ECM training simulation device.

21. The method of claim 17, further comprising determining a digital representation of a training area of the exercise, with all physical structures modelled and/or wherein the method is executed in a virtual space.

22. The method of claim 20, wherein a portable tracking device, approaching or exceeding the simulated protective umbrella, issues a warning perceptible by a member.

23. (canceled)

24. An electronic counter measures, ECM, device configured to operate as a training simulation device in accordance with the system of claim 13, wherein reconfiguration is enabled by a peripheral training device electronically connected to the real operational electronic counter measures device.

25. (canceled)
